(19) United States
(12) Patent Application Publication
(10) Pub. No.: US 2025/0102401 A1
(43) Pub. Date: Mar. 27, 2025

(54) METHOD AND APPARATUS OF DENOISING MECHANICAL VIBRATION SIGNAL, MEDIUM, AND DEVICE

(71) Applicant: Beijing Institute of Aerospace Launch Technology, Beijing (CN)

(72) Inventors: Ximing CHEN, Beijing (CN); Bin ZHANG, Beijing (CN); Jie QIAO, Beijing (CN); Xinsuo GUO, Beijing (CN); Meng ZHAO, Beijing (CN); Zhaoqun CHEN, Beijing (CN); Fang WAN, Beijing (CN); Zhongwei ZHAO, Beijing (CN)

(21) Appl. No.: 18/571,732

(22) PCT Filed: Oct. 11, 2023
(86) PCT No.: PCT/CN2023/124007

§ 371 Date: Dec. 19, 2023

(30) Foreign Application Priority Data
Sep. 25, 2023 (CN) 202311241077.3

(51) Int. Cl. G01M 13/045

(52) U.S. Cl. CPC G01M 13/045

(57) ABSTRACT

The present disclosure provides a method and an apparatus of denoising a mechanical vibration signal, a medium, and a device. The method includes: processing a real-time acquired vibration signal using a generalized variational mode decomposition algorithm GVMD to acquire multiple intrinsic mode function sub signals; clustering the multiple intrinsic mode function sub signals, and dividing the multiple intrinsic mode function sub signals into several categories; and assigning different Gaussian scale coefficients to different categories of intrinsic mode function sub signals, using a non-local means algorithm NLM to filter each intrinsic mode function sub signal, respectively, and summing them, so as to acquire a denoised vibration signal. In the present disclosure, different Gaussian scale coefficients are assigned to different categories of intrinsic mode function sub signals, and the non-local mean algorithm NLM is used to filter each intrinsic mode function sub signal, respectively, improving a denoising effect.

The present disclosure claims priority to the Chinese Patent Application CN2023112410773 filed on Sep. 25, 2023 and entitled “METHOD AND APPARATUS OF DENOISING MECHANICAL VIBRATION SIGNAL, MEDIUM, AND DEVICE”, the disclosure of which is herein incorporated by reference in its entirety.

### TECHNICAL FIELD

The present disclosure belongs to the field of vibration signal processing technologies, and in particular, to a method and an apparatus of denoising a mechanical vibration signal, a medium, and a device.

### BACKGROUND

A mechanical system generates strong vibration signals during operation, which contain rich and useful information. For example, the vibration signals that directly reflect the feature state and operation conditions of a diesel engine are measured at the position of rolling bearings. Therefore, industry researchers generally consider accurately diagnosing fault information of an engine body by analyzing the vibration signals collected from the position of the rolling bearings. However, bearing vibration signals measured on site are easily submerged in strong background noise. Therefore, in order to accurately extract fault features of bearings, it is necessary to effectively identify noise components in a measurement signal and filter them out.

In the current, most commonly used signal denoising methods include empirical mode decomposition (EMD), variational mode decomposition (VMD), and empirical wavelet transform (EWT). However, as a non-linear and non-stationary random signal, time-frequency features of the bearing vibration signal randomly change over time. Therefore, in the case that the above signal denoising methods are directly applied to rolling bearing noise, there are two problems: one is that modal aliasing occurs when processing the vibration signal with strong noise backgrounds, making it difficult to detect internal fault feature information; and the other is that signal distortion is prone to occur during signal decomposition. Therefore, it is necessary to propose a more effective method to solve a problem of signal denoising based on the measured features of the vibration signals of the rolling bearing.

### SUMMARY

In order to solve the above problems existing in the prior art, the present disclosure provides a method and an apparatus of denoising a mechanical vibration signal, a medium, and a device.

To achieve the above object, the present disclosure adopts the following technical solutions.

In the first aspect, the present disclosure provides a method of denoising a mechanical vibration signal, including:
processing a real-time acquired vibration signal using a generalized variational mode decomposition algorithm GVMD to acquire multiple intrinsic mode function sub signals;
clustering the multiple intrinsic mode function sub signals, and dividing the multiple intrinsic mode function sub signals into several categories; and
assigning different Gaussian scale coefficients to different categories of intrinsic mode function sub signals, using a non-local means algorithm NLM to filter each intrinsic mode function sub signal, respectively, and summing them, so as to acquire a denoised vibration signal.

Furthermore, before performing GVMD on the vibration signal, the method further includes preprocessing the vibration signal:
representing the vibration signal as a time series X={x(t)}, where x(t) is an amplitude value of the vibration signal at the t-th data acquisition time, t=1, 2, . . . , N, and N are the number of data;
performing Hampel filtering on X based on the following formula:

$$z ( t ) = \vert x ( t ) - median ( X ) \vert / ( 1.4826 \times median ( Y ) )$$

where in the formula, z(t) is a filtered value of x(t), and medium(X) and medium(Y) are the median of X and Y, respectively, Y={|x(t)−median(X)|}, and t=1, 2, . . . , N; and
where in the case that z(t) is greater than a set threshold value, the z(t) is abnormal data; and
replacing the abnormal data with a numerical value acquired through interpolation calculation.

Furthermore, clustering the multiple intrinsic mode function sub signals using a Kmeans clustering algorithm includes:
determining the number of clusters K, and randomly selecting K intrinsic mode function sub signals from the multiple intrinsic mode function sub signals IMFᵢ(t) as a center hⱼ(t) of an initial sample cluster, where t is data collection time, t=1, 2, . . . , N, N is the number of data, i=1, 2, . . . , M, M is the number of intrinsic mode function sub signals, and j=1, 2, . . . , K;
calculating the Euler distance from each IMFᵢ(t) to each cluster center hⱼ(t) based on the following formula:

$$d ( {IMF}_{i} ( t ) , {h}_{j} ( t ) ) = \sqrt{{\sum }_{t = 1}^{N} {( {IMF}_{i} ( t ) - {h}_{j} ( t ) )}^{2}}$$

where in the formula, d(IMFᵢ(t),hⱼ(t)) is the Euler distance from IMFᵢ(t) to hⱼ(t), i=1, 2, . . . , M, and j=1, 2, . . . , K;
classifying M intrinsic mode function sub signals into centers of K clusters based on the nearest Euler distance criterion to acquire K categories;
calculating an average signal of all intrinsic mode function sub signals in each category, and using the average signal as a new cluster center;
performing iteration by repeating the above steps, where in the case that J_{SSE} is less than the set threshold value, stop the iteration and acquire the final K categories, and a calculation formula for J_{SSE} is:

$${J}_{SSE} = {{\sum }^{K}}_{j = 1} {\sum }_{{IMF}_{i} ∈ {h}_{j}} {min}_{t ∈ [ 1 , N ]} ( \vert {IMF}_{i} ( t ) - {h}_{j} ( t ) \vert )$$

where in the formula, min( ) represents finding a minimum value.

Furthermore, K=3, divide the multiple intrinsic mode function sub signals into 3 categories using the Kmeans clustering algorithm, and where the main signal component of the first category is the vibration signal, the main signal component of the second category is a mixed signal of the vibration signal and the noise signal, and the main signal component of the third category is the noise signal.

Furthermore, a recognition method for the 3 categories includes:
calculating a maximum amplitude value of the intrinsic mode function sub signals for each category; and
sorting the 3 categories in a descending order of the maximum amplitude value, with the first category, the second category, and the third category from top to bottom.

Furthermore, a method of filtering the intrinsic mode function sub signal IMF using the non-local mean algorithm NLM includes:
calculating a weighting coefficient of IMF(i) at the i-th data collection time based on the following formula:

$$ω ( i , j ) = exp ( - \frac{{\sum }_{λ ∈ Δ} {( IMF ( i + λ ) - IMF ( j + λ ) )}^{2}}{( 2 P + 1 ) 2 {δ}_{k}^{2}} )$$

where in the formula, ω(i, j) is a weighting coefficient and is the similarity of similar blocks centered around i, j, δ_{K} is a Gaussian scale coefficient corresponding to the intrinsic mode function sub signal of the k-th category, k=1, 2, 3, δ₁<δ₂<δ₃, P is an influence coefficient related to the number of similar blocks, λ is a search step size, and Δ is a search block centered around i; and

calculating a filtered signal IMFs (i) based on the following formula:

$${IMF}_{S} ( i ) = \frac{1}{M ( i )} {\sum }_{j ∈ {Ω}_{i}} ω ( i , j ) IMF ( j ) \\ M ( i ) = {\sum }_{j ∈ {Ω}_{i}} ω ( i , j )$$

where in the formula, Ωᵢ is a search window centered on i.

Furthermore, δ₁=1, δ₂=4, and δ₃=8.

In the second aspect, the present disclosure provides an apparatus of denoising a mechanical vibration signal, including:
a signal decomposition module, configured to process a real-time acquired vibration signal using a generalized variational mode decomposition algorithm GVMD to acquire multiple intrinsic mode function sub signals;
a signal classification module, configured to cluster the multiple intrinsic mode function sub signals, and divide the multiple intrinsic mode function sub signals into several categories; and
a NLM processing module, configured to assign different Gaussian scale coefficients to different categories of intrinsic mode function sub signals, use a non-local means algorithm NLM to filter each intrinsic mode function sub signal, respectively, and sum them, so as to acquire a denoised vibration signal.

Furthermore, the apparatus further includes a preprocessing module, configured to preprocess the vibration signal:
representing the vibration signal as a time series X={x(t)}, where x(t) is an amplitude value of the vibration signal at the t-th data acquisition time, t=1, 2, . . . , N, and N are the number of data;
performing Hampel filtering on X based on the following formula:

$$z ( t ) = \vert x ( t ) - median ( X ) \vert / ( 1.4826 \times median ( Y ) )$$

where in the formula, z(t) is a filtered value of x(t), and medium(X) and medium(Y) are the median of X and Y, respectively, Y={|x(t)−median (X)|}, and t=1, 2, . . . , N; and
where in the case that z(t) is greater than a set threshold value, the z(t) is abnormal data; and
replacing the abnormal data with a numerical value acquired through interpolation calculation.

Furthermore, clustering the multiple intrinsic mode function sub signals using a Kmeans clustering algorithm includes:
determining the number of clusters K, and randomly selecting K intrinsic mode function sub signals from the multiple intrinsic mode function sub signals IMFᵢ(t) as a center hⱼ(t) of an initial sample cluster, where t is data collection time, t=1, 2, . . . , N, N is the number of data, i=1, 2, . . . , M, M is the number of intrinsic mode function sub signals, and j=1, 2, . . . , K;
calculating the Euler distance from each IMFᵢ(t) to each cluster center hⱼ(t) based on the following formula:

$$d ( {IMF}_{i} ( t ) , {h}_{j} ( t ) ) = \sqrt{{\sum }_{t = 1}^{N} {( {IMF}_{i} ( t ) - {h}_{j} ( t ) )}^{2}}$$

where in the formula, d(IMFᵢ(t),hⱼ(t)) is the Euler distance from IMFᵢ(t) to hⱼ(t), i=1, 2, . . . , M, and j=1, 2, . . . , K;
classifying M intrinsic mode function sub signals into centers of K clusters based on the nearest Euler distance criterion to acquire K categories;
calculating an average signal of all intrinsic mode function sub signals in each category, and using the average signal as a new cluster center;
performing iteration by repeating the above steps, where in the case that J_{SSE} is less than the set threshold value, stop the iteration and acquire the final K categories, and a calculation formula for J_{SSE} is:

$${J}_{SSE} = {{\sum }^{K}}_{j = 1} {\sum }_{{IMF}_{i} ∈ {h}_{j}} {min}_{t ∈ [ 1 , N ]} ( \vert {IMF}_{i} ( t ) - {h}_{j} ( t ) \vert )$$

where in the formula, min( ) represents finding a minimum value.

In the third aspect, the present disclosure provides a readable medium, including execution instructions, where when the execution instructions are run by a processor of an electronic device, the electronic device performs the above method.

In the fourth aspect, the present disclosure provides an electronic device, including a processor and a memory storing execution instructions, where when the execution instructions stored in the memory are executed by the processor, the processor performs the above method.

Compared with the prior art, the present disclosure has the following beneficial effects.

The present disclosure processes a real-time acquired vibration signal using a generalized variational modal decomposition algorithm to acquire multiple intrinsic mode function sub signals, clusters the multiple intrinsic mode function sub signals, divides them into several categories, assigns different Gaussian scale coefficients to the intrinsic mode function sub signals of different categories, and uses a non-local mean algorithm NLM to filter each intrinsic mode function sub signal, respectively, and sums them, so as to acquire a denoised vibration signal, such that the vibration signal is denoised. In the present disclosure, the vibration signal is decomposed into the multiple intrinsic mode function sub signals, different Gaussian scale coefficients are assigned to different categories of intrinsic mode function sub signals, and the non-local mean algorithm NLM is used to filter each intrinsic mode function sub signal, respectively, significantly improving a denoising effect.

### BRIEF DESCRIPTION OF THE DRAWINGS

In order to more clearly illustrate the technical solutions in the embodiments of the present disclosure or the prior art, the drawings required to be used in the description of the embodiments or the prior art are briefly introduced below. It is obvious that the drawings in the description below are merely some embodiments of the present disclosure, and it is obvious for those skilled in the art that other drawings are acquired according to the drawings without creative labor;

FIG. 1 is a flowchart of a method of denoising a mechanical vibration signal according to an embodiment of the present disclosure;

FIG. 2 is a schematic diagram of vibration signal waveform, where small blocks in the figure represent the identified abnormal data;

FIG. 3 is a schematic diagram of applying GVMD to decompose a vibration signal into multiple IMF waveforms;

FIG. 4 is a block diagram of an apparatus of denoising a mechanical vibration signal according to an embodiment of the present disclosure; and

FIG. 5 is a schematic structural diagram of an electronic device according to an embodiment of the present disclosure.

### DETAILED DESCRIPTION

For clearer descriptions of the objects, technical solutions, and beneficial effects of the present disclosure, the specific embodiments of the present disclosure are described in detail below with reference to the drawings. The specific embodiments described are only a part of the embodiments of the present disclosure, not all of them. Based on the specific embodiments of the present disclosure, other embodiments acquired by those skilled in the art without creative labor belong to the protection scope of the present disclosure.

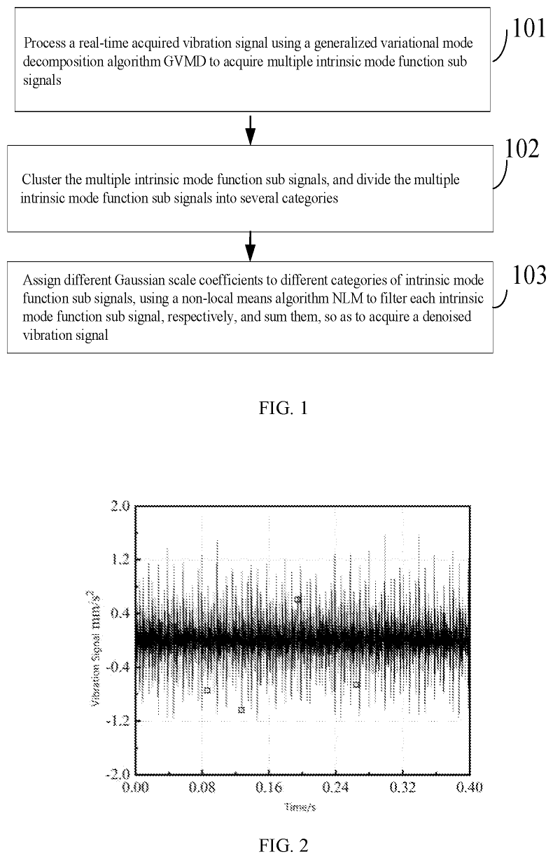

FIG. 1 is a flowchart of a method of denoising a mechanical vibration signal according to an embodiment of the present disclosure, including the following steps.

In step 101, a generalized variational mode decomposition algorithm GVMD is used to process a real-time acquired vibration signal to acquire multiple intrinsic mode function sub signals.

In step 102, the multiple intrinsic mode function sub signals are clustered and divided into several categories.

In step 103, different Gaussian scale coefficients are assigned to different types of intrinsic mode function sub signals, a non-local mean algorithm NLM is used to filter each intrinsic mode function sub signal, respectively, and they are summed, so as to acquire a denoised vibration signal.

In the present embodiment, step 101 is mainly used to decompose the vibration signal into the multiple intrinsic mode function sub signals. The present embodiment processes the vibration signal using the GVMD algorithm to acquire the multiple intrinsic mode function sub signals.

The GVMD algorithm solves an optimization problem of construction by constructing a constrained optimization problem for each sub signal and incorporating a fixed frequency decomposition solution, thereby completing multi-scale fixed frequency decomposition in a frequency domain. Therefore, the GVMD algorithm mainly includes two parts: the construction of constrained optimization problem and the solution of constrained optimization problem. Firstly, assuming that a vibration signal X consists of M sub signals, the optimization problem constructed by GVMD is expressed as:

$$\{ \begin{matrix}{min}_{{u}_{k} , {ω}_{k}} ( {‖ {\partial }_{t} \{ [ δ ( t ) + \frac{j}{π t} ] {u}_{k} ( t ) \} {e}^{- j {ω}_{k} t} ‖}_{2}^{2} ) \\ s . t . {\sum }_{k = 1}^{M} {u}_{k} ( t ) = X ( t )\end{matrix}$$

In the formula, ∂ₜ(*) is a partial derivative of time, t is time; δ(*) is a Dirac function, uₖ is the k-th sub signal, ω_{K} corresponds to a center frequency of the k-th sub signal. Firstly, a multiplier method is used to transform the above constrained optimization problem into an unconstrained optimization problem:

$$L ( {u}_{k} , {ω}_{k} , {λ}_{k} ) = {α}_{k} P {\partial }_{t} \{ [ δ ( t ) + \frac{j}{π t} ] {u}_{k} ( t ) \} {e}^{- j {ω}_{k} t} {P}_{2}^{2} + 〈 {λ}_{k} ( t ) , x ( t ) - {\sum }_{k} {u}_{k} ( t ) 〉 + Px ( t ) - {\sum }_{k} {u}_{k} ( t ) {P}_{2}^{2} ,$$

$$k = 1 , 2 , L , M$$

In the formula, α_{K} represents a scale parameter, and λ_{K} is a Lagrange multiplier. Then an alternating direction method of the multipliers is used to solve the above unconstrained optimization problem, such that the main problem is decomposed into 3 sub problems: minimization of sub signal uₖ, minimization of center frequency ωₖ, and improvement of Lagrange multiplier λₖ. The specific formula is as follows:

$${u}_{k}^{n + 1} = {arg min}_{{u}_{k} ∈ X} \{ {α}_{k} {‖ {\partial }_{t} [ ( δ ( t ) + \frac{j}{π t} ) * {u}_{k} ( t ) ] {e}^{- j {ω}_{k} t} ‖}_{2}^{2} + {‖ x ( t ) - {\sum }_{k = 1}^{K} {u}_{k} ( t ) + \frac{{λ}_{k} ( t )}{2} ‖}_{2}^{2} \} \\ {ω}_{k}^{n + 1} = {arg min}_{{ω}_{k}} \{ {α}_{k} {‖ {\partial }_{t} [ ( δ ( t ) + \frac{j}{π t} ) * {u}_{k} ( t ) ] {e}^{- j {ω}_{k} t} ‖}_{2}^{2} \} \\ {λ}_{k}^{n + 1} = {λ}_{k}^{n} + τ ( x - {{\sum }_{k = 1}}^{K} {u}_{k}^{n + 1} )$$

In the formula, a parameter τ is a dual ascending step size, and n is an iteration step

Finally, all 3 sub problems are solved by iteratively updating uₖ, ω_{K}, and λ_{K}. The acquired sub signal and center frequency are:

$${\hat{u}}_{k}^{n + 1} ( ω ) = \frac{\hat{x} ( ω ) - {\sum }_{{i = 1}_{i \neq k}}^{K} {u}_{i} ( ω ) + \frac{{\hat{λ}}_{k} ( ω )}{2}}{1 + 2 {{α}_{k} ( ω - {ω}_{k}^{n} )}^{2}} \\ {ω}_{k}^{n + 1} = \frac{{\int }_{0}^{∞} ω {\vert {\hat{u}}_{k} ( ω ) \vert}^{2} d ω}{{\int }_{0}^{∞} {\vert {\hat{u}}_{k} ( ω ) \vert}^{2} d ω}$$

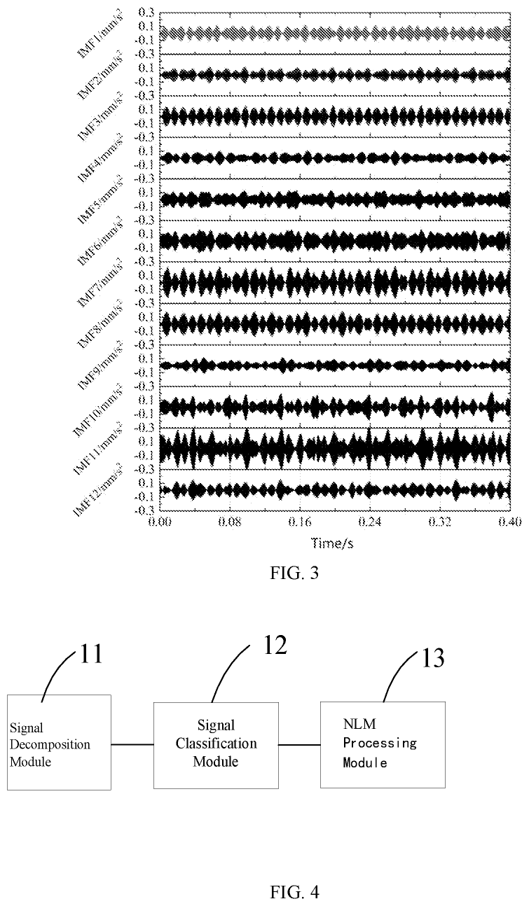

In the formula, \hat{x}, û, and \hat{λ} are the Fourier transform of x, u, and λ, respectively. A real part of the inverse Fourier transform is the sub signal uₖ, which is also the intrinsic mode function IMF. FIG. 3 is a schematic diagram of IMF acquired by decomposing a vibration signal using a GVMD method.

In the present embodiment, step 102 is mainly used to classify the multiple intrinsic mode function sub signals. A purpose of classifying the intrinsic mode function sub signals is to classify sub signals with similar features into the same category, and filter sub signals of different categories in a targeted manner to acquire an ideal filtering and denoising effect. In the prior art, there are many available classification algorithms, which is not limited in the present embodiment. The following embodiments will provide a specific classification algorithm.

In the present embodiment, step 103 is mainly used to filter different types of intrinsic mode function sub signals. The present embodiment uses the non-local mean algorithm NLM to filter each intrinsic mode function sub signal, respectively. The NLM algorithm effectively reduces the noise while reducing signal distortion. In order to achieve the ideal filtering and denoising effect, the present embodiment assigns different Gaussian scale coefficients to different categories of sub signals, filters each sub signal, respectively, and sums them, so as to acquire the denoised vibration signal.

As one optional embodiment, the method further includes preprocessing the vibration signal before performing GVMD.

The vibration signal is represented as a time series X={x(t)}, where x(t) is an amplitude value of the vibration signal at the t-th data acquisition time, t=1, 2, . . . , N, and N are the number of data;

Hampel filtering is performed on X using the following formula:

$$z ( t ) = \vert x ( t ) - median ( X ) \vert / ( 1.4826 \times median ( Y ) ) \qquad ( 1 )$$

In the formula, z(t) is a filtered value of x(t), and medium(X) and medium(Y) are the median of X and Y, respectively, Y={|x(t)−median (X)|}, and t=1, 2, . . . , N.

In the case that z(t) is greater than a set threshold, the z(t) is abnormal data.

The abnormal data is replaced with a numerical value acquired through interpolation calculation.

The present embodiment provides a technical solution of preprocessing the vibration signal. During an on-site process of collecting the vibration signal, measurement errors and interference signals are prone to occur, resulting in the presence of abnormal data points in the signal, as shown in FIG. 2. The present embodiment uses a Hampel filtering method to process the vibration signal and identify the abnormal data points. Hampel filtering, as a mean filter, designs a probability distribution model for known data, such that the abnormal data points are identified due to significant differences from expectations of the probability model. A calculation formula of performing the Hampel filtering on the vibration signal is shown as the formula (1). By comparing the filtered data with the set threshold value, in the case that a value of a certain data point exceeds the set threshold value, it is considered an abnormal data point. In order to eliminate an adverse effect of the abnormal data points, these abnormal data points are removed and replaced with numerical values acquired through an interpolation method. There are many existing interpolation algorithms, the simplest of which is a linear interpolation method. In order to achieve high accuracy, fourth order polynomial fitting interpolation of least squares method is used.

As one optional embodiment, the Kmeans clustering algorithm is used to cluster the multiple intrinsic mode function sub signals.

The number of clusters K is determined, and K intrinsic mode function sub signals are randomly selected from the multiple intrinsic mode function sub signals IMFᵢ(t) as a center hⱼ(t) of an initial sample cluster, where t is data collection tine, t=1, 2, . . . , N, N is the number of data, i=1, 2, . . . , M, M is the number of intrinsic mode function sub signals, and j=1, 2, . . . , K.

The Euler distance is calculated from each IMFᵢ(t) to each cluster center hⱼ(t) using the following formula:

$$d ( I M {F}_{i} ( t ) , {h}_{j} ( t ) ) = \sqrt{{\sum }_{t = 1}^{N} {( I M {F}_{i} ( t ) - {h}_{j} ( t ) )}^{2}} \qquad ( 2 )$$

In the formula, d(IMFᵢ(t),hⱼ(t)) is the Euler distance from IMFᵢ(t) to hⱼ(t), i=1, 2, . . . , M, and j=1, 2, . . . , K.

Based on the nearest Euler distance criterion, M intrinsic mode function sub signals are classified into centers of K clusters to acquire K categories.

An average signal of all intrinsic module function sub signals in each category is calculated and used as a new cluster center.

Iteration is performed by repeating the above steps, and in the case that J_{SSE} is less than the set threshold value, stop the iteration and acquire the final K categories, and a calculation formula for J_{SSE} is:

$${J}_{S S E} = {{\sum }_{j = 1}}^{K} {\sum }_{{IMF}_{i} ∈ {h}_{j}} {min}_{t ∈ [ 1 , N ]} ( \vert {IMF}_{i} ( t ) - {h}_{j} ( t ) \vert ) \qquad ( 3 )$$

In the formula, min( ) represents finding a minimum value.

The present embodiment provides a specific classification algorithm. The present embodiment uses the Kmeans clustering algorithm to cluster the multiple intrinsic mode function sub signals. The Kmeans clustering algorithm is the most commonly used clustering algorithm and also an unsupervised learning algorithm. The core idea of the Kmeans algorithm is as follows: firstly, determine the number of clusters K, randomly select K initial cluster centers Ci from a data set, calculate the Euclidean distance between the remaining data and the cluster center Ci, find the cluster center Ci closest to the data, and assign the data to a cluster corresponding to the cluster center Ci; then calculate an average value of data objects in each cluster as a new cluster center, and proceed to the next iteration until the cluster center no longer changes or reaches the maximum number of iterations. The present embodiment differs from general clustering operations in that the cluster center is not a single data point, but rather all data points contained in one sub signal. Of course, the object of classification is not specific to a single data point. Rather, one sub signal is regarded as a whole when it is classified.

As one optional embodiment, K=3, the multiple intrinsic mode function sub signals are divided into 3 categories using the Kmeans clustering algorithm. The main signal component of the first category is the vibration signal, the main signal component of the second category is a mixed signal of the vibration signal and the noise signal, and the main signal component of the third category is the noise signal.

The present embodiment limits the number of clusters K. The present embodiment limits K=3, and after performing the Kmeans clustering algorithm, the 3 categories of intrinsic mode function sub signals are acquired. The 3 categories are basically classified based on signal energy or intensity: the first category is the strongest sub signal, and the main signal component is the vibration signal; the second category is the strong sub signal, and the main signal component is the mixed signal of the vibration signal and the noise signal; and the third category is the weakest sub signal, and the main signal component is the noise signal.

As one optional embodiment, an identification method for the 3 categories is as follows.

A maximum amplitude value of the intrinsic mode function sub signals for each category is calculated.

The 3 categories are sorted in a descending order of maximum amplitude value, with the first category, the second category, and the third category from top to bottom.

The present embodiment provides the recognition method for the 3 categories. Although the previous embodiment has acquired the 3 categories, the signal component of each category is not known. That is, it is not known which category is the first category, the second category, and the third category. The present embodiment calculates the maximum amplitude values of all sub signals in each category and sorts them by size, with the first category, the second category, and the third category from top to bottom. Of course, the comparison is made based on the signal mean of each cluster center in each category. In short, all the 3 categories are distinguished based on the signal strength.

As one optional embodiment, a method of filtering the intrinsic mode function sub signal IMF using the non-local mean algorithm NLM is as follows.

A weighting coefficient of IMF(i) at the i-th data collection time is calculated based on the following formula.

$$ω ( i , j ) = exp ( - \frac{{\sum }_{λ ∈ Δ} {( IMF ( i + λ ) - IMF ( j + λ ) )}^{2}}{( 2 P + 1 ) 2 {δ}_{k}^{2}} ) \qquad ( 4 )$$

In the formula, in the formula, ω(i, j) is a weighting coefficient and is the similarity of similar blocks centered around i, j, δ_{K} is a Gaussian scale coefficient corresponding to the intrinsic mode function sub signal of the k-th category, k=1, 2, 3, δ₁<δ₂<δ₃, P is an influence coefficient related to the number of similar blocks, λ is a search step size, and Δ is a search block centered around i.

A filtered signal IMF_{S}(i) is calculated based on the following formula:

$$I M {F}_{S} ( i ) = \frac{1}{M ( i )} {\sum }_{j ∈ {Ω}_{i}} ω ( i , j ) IMF ( j ) \qquad ( 5 )$$

$$M ( i ) = {\sum }_{j ∈ {Ω}_{i}} ω ( i , j ) \qquad ( 6 )$$

In the formula, Ωᵢ is a search window centered on i.

The present embodiment provides one technical solution of filtering the intrinsic mode function sub signal using the NLM algorithm. The present embodiment filters the IMF sub signal by calculating the weighting mean of IMF sub signals within each search window Ωi, and the calculation formulas are shown as formulas (5) and (6). The larger the width of the search window Ωi, the better the denoising effect, but the longer the calculation time. ω(i, j) is the weighting coefficient, and the calculation formula is shown as formula (4). The calculation process of ω(i, j) is understood as comparing domains around similar blocks centered around i and j, the higher the similarity, the larger the ω(i, j). δ_{K} is the Gaussian scale coefficient, which affects the smoothness of a denoise signal. P is the coefficient variable affecting ω(i, j), which affects the number of similar blocks. λ represents the search step size, which is a step size of movement of the search window. Δ is the search block centered around i. All of Ωᵢ, δ_{K} and P have an impact on the result of NLM, but it is clearly seen from formula (4) that the influence of the Gaussian scale coefficient δₖ is greater than that of other two parameters. In order to achieve a good filtering result, the present embodiment adopts Gaussian scale coefficients of different sizes for different signal components, δ_{K} is the Gaussian scale coefficient corresponding to the IMF sub signal of the k-th category, where k=1, 2, and 3. Due to the successive decrease in signal energy from the first to third category, δ₁<δ₂<δ₃, the third category has the largest Gaussian scale coefficient, which effectively suppresses the noise signal.

As one optional embodiment, δ₁=1, δ₂=4, and δ₃=8.

The present embodiment provides a set of specific numerical values for the 3 categories of Gaussian scale coefficients. δ₁, δ₂, δ₃ are 1, 4, and 8, respectively, satisfying δ₁<δ₂<δ₃. It is noted that the present embodiment merely provides a better implementation manner but does not exclude or negate other feasible implementation manners, for example, δₖ is different from the value of the present embodiment.

FIG. 4 is a schematic diagram of composition of an apparatus of denoising a mechanical vibration signal according to an embodiment of the present disclosure, where the apparatus includes:
a signal decomposition module 11, configured to process a real-time acquired vibration signal using a generalized variational mode decomposition algorithm GVMD to acquire multiple intrinsic mode function sub signals;
a signal classification module 12, configured to cluster the multiple intrinsic mode function sub signals, and divide the multiple intrinsic mode function sub signals into several categories; and
a NLM processing module 13, configured to assign\ different Gaussian scale coefficients to different categories of intrinsic mode function sub signals, use a non-local means algorithm NLM to filter each intrinsic mode function sub signal, respectively, and sum them, so as to acquire a denoised vibration signal.

The apparatus of the present embodiment is used to perform the technical solution of the method embodiment shown in FIG. 1. The implementation principle and technical effect thereof are similar and will not be repeated herein. The following embodiments are also the same and will not be further explained.

As one optional embodiment, the apparatus further includes a preprocessing module configured to preprocess the vibration signal.

The vibration signal is represented as a time series X={x(t)}, where x(t) is an amplitude value of the vibration signal at the t-th data acquisition time, t=1, 2, . . . , N, and N are the number of data;

Hampel filtering is performed on X using the following formula:

$$z ( t ) = \vert x ( t ) - median ( X ) \vert / ( 1.4826 \times median ( Y ) ) \qquad ( 1 )$$

In the formula, z(t) is a filtered value of x(t), and medium(X) and medium(Y) are the median of X and Y, respectively, Y={|x(t)−median (X)|}, and t=1, 2, . . . , N.

In the case that z(t) is greater than a set threshold value, the z(t) is abnormal data.

The abnormal data is replaced with a numerical value acquired through interpolation calculation.

As one optional embodiment, the Kmeans clustering algorithm is used to cluster the multiple intrinsic mode function sub signals.

The number of clusters K is determined, and K intrinsic mode function sub signals are randomly selected from the multiple intrinsic mode function sub signals IMFᵢ(t) as a center hⱼ(t) of an initial sample cluster, where t is data collection time, t=1, 2, . . . , N, N is the number of data, i=1, 2, . . . , M, M is the number of intrinsic mode function sub signals, and j=1, 2, . . . , K.

The Euler distance is calculated from each IMFᵢ(t) to each cluster center hⱼ(t) based on the following formula:

$$d ( I M {F}_{i} ( t ) , {h}_{j} ( t ) ) = \sqrt{{\sum }_{t = 1}^{N} {( I M {F}_{i} ( t ) - {h}_{j} ( t ) )}^{2}} \qquad ( 2 )$$

In the formula, d(IMFᵢ(t),hⱼ(t)) is the Euler distance from IMFᵢ(t) to hⱼ(t), i=1, 2, . . . , M, and j=1, 2, . . . , K.

Based on the nearest Euler distance criterion, M intrinsic mode function sub signals are classified into centers of K clusters to acquire K categories.

An average signal of all intrinsic mode function sub signals in each category is calculated and used as a new cluster center.

Iteration is performed by repeating the above steps, and in the case that J_{SSE} is less than the set threshold value, stop the iteration and acquire the final K categories, and a calculation formula of J_{SSE} is:

$${J}_{S S E} = {{\sum }_{j = 1}}^{K} {\sum }_{{IMF}_{i} ∈ {h}_{j}} {min}_{t ∈ [ 1 , N ]} ( \vert {IMF}_{i} ( t ) - {h}_{j} ( t ) \vert ) \qquad ( 3 )$$

In the formula, min( ) represents finding a minimum value.

The above are only specific embodiments of the present disclosure, but the protection scope of the present disclosure is not limited thereto. Any changes or alternations easily thought of by those skilled familiar with the technical field within the technical scope of the present disclosure should be covered within the protection scope of the present disclosure. Therefore, the protection scope of the present disclosure is based on the protection scope of the claims.

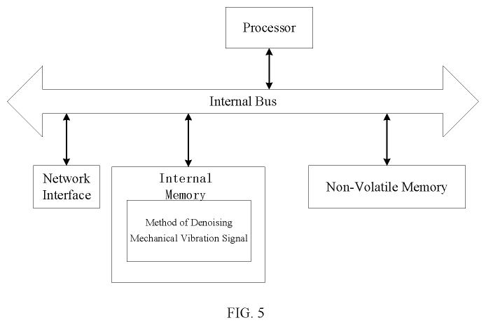

FIG. 5 is a schematic structural diagram of an electronic device according to an embodiment of the present disclosure. At the hardware level, the electronic device includes a processor, optionally includes an internal bus, a network interface, and a memory. The memory includes internal memory, such as high-speed random-access memory (RAM), or it further includes non-volatile memory, such as at least 1 disk memory. Of course, the electronic device further includes the hardware required for other businesses.

The processor, network interface, and memory are connected to each other through the internal bus, which is an ISA (Industry Standard Architecture) bus, a PCI (Peripheral Component Interconnect) bus, or an EISA (Extended Industry Standard Architecture) bus, and the like. The bus is divided into address bus, data bus, control bus, and the like. For ease of illustration, only 1 bidirectional arrow is used in FIG. 5, but it does not mean that there is only 1 bus or 1 type of bus.

The memory is configured to store execution instructions. Specifically, the execution instruction is a computer program that can be run. The memory includes the internal memory and non-volatile memory, and provides the execution instructions and data to the processor.

In one possible implementation manner, the processor reads corresponding execution instructions from the non-volatile memory into the internal memory and runs them, or it acquires corresponding execution instructions from other devices to form a blood vessel segmentation apparatus at the logical level. The processor executes the execution instructions stored in the memory to achieve the method of denoising the mechanical vibration signal according to any one embodiment of the present disclosure through the executed execution instructions.

The method of denoising the mechanical vibration signal according to the embodiment shown in FIG. 1 of the present disclosure is applied to the processor or implemented by the processor. The processor is an integrated circuit chip with signal processing capabilities. During the implementation process, each step of the above method is completed by means of the integrated logic circuit of the hardware in the processor or instructions in the form of the software. The above processor is a general-purpose processor, including Central Processing Unit (CPU), Network Processor (NP), and the like; and it is also a Digital Signal Processor (DSP), Application Specific Integrated Circuit (ASIC), Field Programmable Gate Array (FPGA) or other programmable logic devices, discrete gate or transistor logic devices, or discrete hardware components. The disclosed methods, steps, and logical block diagrams in the embodiments of the present disclosure are implemented or executed. The general-purpose processor is a microprocessor or any conventional processor.

The steps of the method disclosed in the embodiments of the present disclosure are directly performed by a hardware decoding processor, or performed by combining hardware and software modules in the decoding processor. The software module is located in mature storage media in the field, such as random access memory, flash memory, read-only memory, programmable read-only memory, or electrically erasable programmable memory, register. The storage medium is located in the memory, and the processor reads information in the memory and completes the steps of the above method combined with the hardware thereof.

### INDUSTRIAL APPLICABILITY

The present disclosure provides a method and an apparatus of denoising a mechanical vibration signal, a medium, and a device, which decomposes the vibration signal into multiple intrinsic mode function sub signals, assigns different Gaussian scale coefficients to different types of intrinsic mode function sub signals, and uses a non-local mean calculation method NLM to filter each intrinsic mode function sub signal, respectively, significantly improving a denoising effect. It can be combined with computer technology to form a signal processing apparatus and for device mass production, quickly applied to a system or a scenario with high demand for vibration signal analysis.

1. A method of denoising a mechanical vibration signal, comprising:
processing a real-time acquired vibration signal using a generalized variational mode decomposition algorithm GVMD to acquire multiple intrinsic mode function sub signals;
clustering the multiple intrinsic mode function sub signals, and dividing the multiple intrinsic mode function sub signals into several categories; and
assigning different Gaussian scale coefficients to different categories of intrinsic mode function sub signals, using a non-local means algorithm NLM to filter each intrinsic mode function sub signal, respectively, and summing them, so as to acquire a denoised vibration signal.

2. The method of denoising the mechanical vibration signal according to claim 1, wherein before performing GVMD on the vibration signal, the method further comprises preprocessing the vibration signal:
representing the vibration signal as a time series X={x(t)}, wherein x(t) is an amplitude value of the vibration signal at the t-th data acquisition time, t=1, 2, . . . , N, and N are the number of data;
performing Hampel filtering on X based on the following formula:
$$z ( t ) = \vert x ( t ) - median ( X ) \vert / ( 1.4826 \times median ( Y ) )$$
wherein in the formula, z(t) is a filtered value of x(t), and medium(X) and medium(Y) are the median of X and Y, respectively, Y={|x(t)−median (X)|}, and t=1, 2, . . . , N; and
wherein in the case that z(t) is greater than a set threshold value, the z(t) is abnormal data; and
replacing the abnormal data with a numerical value acquired through interpolation calculation.

3. The method of denoising the mechanical vibration signal according to claim 1, wherein clustering the multiple intrinsic mode function sub signals using a Kmeans clustering algorithm comprises:
determining the number of clusters K, and randomly selecting K intrinsic mode function sub signals from the multiple intrinsic mode function sub signals IMFᵢ(t) as a center hⱼ(t) of an initial sample cluster, wherein tis data collection time, t=1, 2, . . . , N, N is the number of data, i=1, 2, . . . , M, M is the number of intrinsic mode function sub signals, and j=1, 2, . . . , K;
calculating the Euler distance from each IMFᵢ(t) to each cluster center hⱼ(t) based on the following formula:
$$d ( IM {F}_{i} ( t ) , {h}_{j} ( t ) ) = \sqrt{{\sum }_{t = 1}^{N} {( I M {F}_{i} ( t ) - {h}_{j} ( t ) )}^{2}}$$
wherein in the formula, d(IMFᵢ(t),hⱼ(t)) is the Euler distance from IMFᵢ(t) to hⱼ(t), i=1, 2, . . . , M, and j=1, 2, . . . , K;
classifying M intrinsic mode function sub signals into centers of K clusters based on the nearest Euler distance criterion to acquire K categories;
calculating an average signal of all intrinsic mode function sub signals in each category, and using the average signal as a new cluster center;
performing iteration by repeating the above steps, wherein in the case that J_{SSE} is less than the set threshold value, stop the iteration and acquire the final K categories, and a calculation formula for J_{SSE} is:
$${J}_{S S E} = {{\sum }_{j = 1}}^{K} {\sum }_{{IMF}_{i} ∈ {h}_{j}} {min}_{t ∈ [ 1 , N ]} ( \vert {IMF}_{i} ( t ) - {h}_{j} ( t ) \vert )$$
wherein in the formula, min( ) represents finding a minimum value.

4. The method of denoising the mechanical vibration signal according to claim 3, wherein K=3, divide the multiple intrinsic mode function sub signals into 3 categories using the Kmeans clustering algorithm, and wherein the main signal component of the first category is the vibration signal, the main signal component of the second category is a mixed signal of the vibration signal and the noise signal, and the main signal component of the third category is the noise signal.

5. The method of denoising the mechanical vibration signal according to according to claim 4, wherein a recognition method for the 3 categories comprises:
calculating a maximum amplitude value of the intrinsic mode function sub signals for each category; and
sorting the 3 categories in a descending order of the maximum amplitude value, with the first category, the second category, and the third category from top to bottom.

6. The method of denoising the mechanical vibration signal according to claim 5, wherein a method of filtering the intrinsic mode function sub signal IMF using the non-local mean algorithm NLM comprises:
calculating a weighting coefficient of IMF(i) at the i-th data collection time based on the following formula:
$$ω ( i , j ) = exp ( - \frac{{\sum }_{λ ∈ Δ} {( IMF ( i + λ ) - IMF ( j + λ ) )}^{2}}{( 2 P + 1 ) 2 {δ}_{k}^{2}} )$$
wherein in the formula, ω(i, j) is a weighting coefficient and is the similarity of similar blocks centered around i, j, δ_{K} is a Gaussian scale coefficient corresponding to the intrinsic mode function sub signal of the k-th category, k=1, 2, 3, δ₁<δ₂<δ₃, P is an influence coefficient related to the number of similar blocks, λ is a search step size, and Δ is a search block centered around i; and
calculating a filtered signal IMF_{S}(i) based on the following formula:
$$IM {F}_{S} ( i ) = \frac{1}{M ( i )} {\sum }_{j ∈ {Ω}_{i}} ω ( i , j ) IMF ( j )$$
$$M ( i ) = {\sum }_{j ∈ {Ω}_{i}} ω ( i , j )$$
wherein in the formula, Ωᵢ is a search window centered on i.

7. The method of denoising the mechanical vibration signal according to claim 6, wherein δ₁=1, δ₂=4, and δ₃=8.

8. An apparatus of denoising a mechanical vibration signal, comprising:
a signal decomposition module, configured to process a real-time acquired vibration signal using a generalized variational mode decomposition algorithm GVMD to acquire multiple intrinsic mode function sub signals;
a signal classification module, configured to cluster the multiple intrinsic mode function sub signals, and divide the multiple intrinsic mode function sub signals into several categories; and
a NLM processing module, configured to assign different Gaussian scale coefficients to different categories of intrinsic mode function sub signals, use a non-local means algorithm NLM to filter each intrinsic mode function sub signal, respectively, and sum them, so as to acquire a denoised vibration signal.

9. The apparatus of denoising the mechanical vibration signal according to claim 8, wherein the apparatus further comprises a preprocessing module, configured to preprocess the vibration signal:
representing the vibration signal as a time series X={|x(t)}, wherein x(t) is an amplitude value of the vibration signal at the t-th data acquisition time, t=1, 2, . . . , N, and N are the number of data;
performing Hampel filtering on X based on the following formula:
$$z ( t ) = \vert x ( t ) - median ( X ) \vert / ( 1.4826 \times median ( Y ) )$$
wherein in the formula, z(t) is a filtered value of x(t), and medium(X) and medium(Y) are the median of X and Y, respectively, Y={|x(t)−median (X)|}, and t=1, 2, . . . , N; and
wherein in the case that z(t) is greater than a set threshold value, the z(t) is abnormal data; and
replacing the abnormal data with a numerical value acquired through interpolation calculation.

10. The apparatus of denoising the mechanical vibration signal according to claim 8, wherein clustering the multiple intrinsic mode function sub signals using a Kmeans clustering algorithm comprises:
determining the number of clusters K, and randomly selecting K intrinsic mode function sub signals from the multiple intrinsic mode function sub signals IMFᵢ(t) as a center hⱼ(t) of an initial sample cluster, wherein tis data collection time, t=1, 2, . . . , N, N is the number of data, i=1, 2, . . . , M, M is the number of intrinsic mode function sub signals, and j=1, 2, . . . , K;
calculating the Euler distance from each IMFᵢ(t) to each cluster center hⱼ(t) based on the following formula:
$$d ( IM {F}_{i} ( t ) , {h}_{j} ( t ) ) = \sqrt{{\sum }_{t = 1}^{N} {( I M {F}_{i} ( t ) - {h}_{j} ( t ) )}^{2}}$$
wherein in the formula, d(IMFᵢ(t),hⱼ(t)) is the Euler distance from IMFᵢ(t) to hⱼ(t), i=1, 2, . . . , M, and j=1, 2, . . . , K;
classifying M intrinsic mode function sub signals into centers of K clusters based on the nearest Euler distance criterion to acquire K categories;
calculating an average signal of all intrinsic mode function sub signals in each category, and using the average signal as a new cluster center;
performing iteration by repeating the above steps, wherein in the case that J_{SSE} is less than the set threshold value, stop the iteration and acquire the final K categories, and a calculation formula for J_{SSE} is:
$${J}_{S S E} = {{\sum }_{j = 1}}^{K} {\sum }_{{IMF}_{i} ∈ {h}_{j}} {min}_{t ∈ [ 1 , N ]} ( \vert {IMF}_{i} ( t ) - {h}_{j} ( t ) \vert )$$
wherein in the formula, min( ) represents finding a minimum value.

11. (canceled)

12. (canceled)
